(19) United States
(12) Patent Application Publication
(10) Pub. No.: US 2008/0156744 A1
(43) Pub. Date: Jul. 3, 2008

(54) Flow Separator And Flow Separator Method

(76) Inventors: Ian Atkinson, Cambridgeshire (GB); Gary Oddie, Cambridgeshire (GB); David Scott, Cambridgeshire (GB)

Correspondence Address: SCHLUMBERGER-DOLL RESEARCH;ATTN: INTELLECTUAL PROPERTY LAW DEPARTMENT, P.O. BOX 425045, CAMBRIDGE, MA, 02142, US

(21) Appl. No.: 11/667,636

(22) PCT Filed: Nov. 18, 2005
(86) PCT No.: PCT/GB05/04439

§ 371 Date: Dec. 12, 2007

(30) Foreign Application Priority Data
Nov. 20, 2004 (GB) 0425597.2

(51) Int. Cl. B01D 37/00; B01D 35/02

(52) U.S. Cl. 210/787; 210/151

(57) ABSTRACT

Disclosed is a flow separator, typically for use in separating liquid from gas in a flowing mixture of liquid and gas, e.g. water, oil and gas in a hydrocarbon well production fluid pipeline, the separator having a swirl generator disposed at the inlet to a cylindrical separation chamber and the separation chamber having an elongate liquid extraction slot formed along its wall, such that in operation the swirling flow centrifugally pushes the liquid towards the wall of the separation chamber to exit the separation chamber through the extraction slot into a collection chamber which may allow the return of the extracted liquid back into the main flow using a U-shaped tube.

### BACKGROUND TO THE INVENTION

1. Field of the Invention

The present invention relates to a flow separator for separating liquid from a flowing mixture of liquid and gas. The invention also relates to a method for such separation. The invention is of interest, for example, in separation of liquid from gas for the purposes of measurement in flows of hydrocarbon well production fluid. The separator may be used as part of a system to measure the gas, oil and water flow rates of a multiphase flowing mixture. These can be derived, for example, from a Venturi pressure difference measurement, a total liquid flow rate measurement and a water liquid ratio measurement.

2. Related Art

The determination of gas and liquid flow rates in gas-liquid mixtures are important measurements in the oil and gas industry.

The gas volume fraction (GVF) is defined as the gas volumetric flow rate divided by the total volumetric flow rate of the gas-liquid mixture. It is possible to define the following nomenclature for different market applications in the oil and gas industry. For oil wells, a normal GVF is less than 92%, a high GVF is between 92% and 96% and a very high GVF is more than 96%. Ageing oil wells produce more gas and water moving towards high GVF and very high GVF. For gas production, a wet gas is any liquid-loaded gas well. Such gas wells provide water and condensate in the production fluid as the well ages.

It is desirable to be able to measure from such wells, at line conditions, the gas, water and liquid hydrocarbon volumetric flow rates, or quantities that are functions of these values.

An example of an apparatus for measuring such flow rates is Schlumberger's PhaseTester™ VenturiX™ system (see, for example, I. Atkinson, M. Berard, B. V. Hanssen, G. Ségéral, 17^{th} International North Sea Flow Measurement Workshop, Oslo, Norway 25-28 Oct. 1999 “New Generation Multiphase Flowmeters from Schlumberger and Framo Engineering AS”;) which comprises a vertically mounted Venturi flow meter, a dual energy gamma-ray hold-up measuring device and associated processors. This system successfully allows the simultaneous calculation of gas, water and oil volumetric flow rates in multi phase flows.

However, with conventional implementations of Venturix™ technology the accuracy of the calculations starts to degrade as the GVF increases above about 85%. This can be a problem because as oil wells age the GVF increases towards 100% and as gas wells age the GVF decreases from 100%. One reason for the drop in accuracy is that at low mixture densities (i.e. high GVFs) the accuracy of high-energy gamma-ray density measurements starts to fall. In general, there are difficulties with existing technologies in measuring small fractions of liquids.

WO 02/16822 and GB-B-2366220 disclose a device for diverting a liquid from a pipeline. The content of those documents is hereby incorporated by reference. The device disclosed is of use in separating liquid from a multi-phase flow in a pipeline. A flowing mixture is allowed to flow into a first conduit of the device. The liquid is separated from the device by a baffle plate located in the first conduit, so that the liquid is entrained in the annular region around the baffle plate and gas can flow over a lip of the annular baffle plate and onwards along the pipeline. These documents suggest that the inlet to the first conduit might be tangential, thereby assisting separation of the liquid from the gas via centrifugal force. Liquid entrained in the first conduit is allowed to flow to a second conduit in communication with the first conduit. The liquid is allowed to return to rejoin the flow after appropriate metering.

### SUMMARY OF THE INVENTION

The present inventors have realised that there are problems with the device disclosed in WO 02/16822 and GB-B-2366220. In particular, the device may not provide adequate or reliable separation at relatively high liquid flow rates. There is, therefore, a need to provide an alternative flow separator and/or an alternative separation method that addresses the above problem, preferably solving the above problem.

Accordingly, in a first aspect, the present invention provides a flow separator for separating liquid from a flowing mixture of liquid and gas having:
an inlet for the flowing mixture;
swirl promotion means;
a first outlet for separated liquid;
a second outlet for the remaining flow;
a separation chamber with an extraction aperture for extracting the liquid to be separated; and
a collection chamber communicating with the first outlet and arranged to collect the separated liquid extracted through the extraction aperture from the separation chamber;
   wherein, in use, the swirl promotion means promotes a swirling flow of the flowing mixture in the separation chamber and an internal surface of the separation chamber guides the swirling liquid to be separated to the extraction aperture, which is located along the swirl path of the liquid to be separated.

In this way, the invention provides centrifugal separation of the liquid, the separated liquid being extracted via the extraction aperture.

Preferably, the inner surface of the separation chamber provides a smooth curved path for the swirling liquid to the extraction aperture. This helps to improve the separation efficiency of the separator. Typically, the inner surface of the separation chamber is at least partly cylindrical. This allows the angular velocity of the swirling liquid to be substantially uniform around the separation chamber, again improving the separation efficiency.

Preferably, the extraction aperture is formed so as to encourage the swirling liquid exiting the separation chamber via the aperture to continue in a direction which is substantially tangential to the inner wall of the separation chamber. In this way, the turbulence of the flow of the liquid is ideally not increased on extraction from the separation chamber, since this extraction geometry causes as little disturbance as possible to the instantaneous flow direction of the liquid as it encounters the extraction aperture.

Preferably, the separation chamber has a swirl guide disposed on its inner surface to assist in promoting swirling flow of the liquid within the separation chamber. It is considered that the steeper the swirl within the separation chamber, the more efficient the separation of liquid. Thus, the swirl guide can give rise to more efficient separation of liquid. Typically, the swirl guide is a helical ridge or insert disposed against the internal surface of the wall of the separation chamber.

There may be a plurality of extraction apertures, e.g. arranged in a line substantially parallel to the longitudinal axis of the separation chamber. However, preferably the extraction aperture is a slot, extending in a direction substantially parallel to the longitudinal axis of the separation chamber.

Preferably, the extraction aperture has a face surface that is substantially aligned with the exit direction of the liquid. This is to avoid the liquid impinging on that face and thereby being diverted back into the separation chamber and/or preventing subsequent liquid from exiting the separation chamber. This face is typically on the side of the slot opposing the flow of liquid from the separation chamber.

Preferably, the collection chamber has a smooth inner surface for guiding liquid extracted from the separation chamber to a reservoir region of the collection chamber. Again, this is to provide the collected liquid with as little additional turbulence in its flow as possible so that it is guided smoothly to collect at the base of the collection chamber.

The separation chamber may be located within the collection chamber so that the exit direction of the liquid from the extraction aperture makes an angle of 45° or less with the tangent to the inner surface of the collection chamber. This may act to reduce the turbulence of the liquid after it impinges on the inner surface of the collection chamber. Preferably, the separation chamber, extraction aperture and collection chamber are arranged to reduce mixing of the liquid extracted through the extraction aperture and to reduce the impact of the liquid as it impinges on the inner surface of the collection chamber.

Preferably, angled guide means is provided externally of the extraction aperture to guide the exiting liquid in an axial direction along the collection chamber. The angled guide means may be disposed between the inner surface of the wall of the collection chamber and the outer surface of the wall of the separation chamber. This angled guide means allows the partial baffling of the exiting liquid from the extraction aperture (reducing its speed). It also directs the liquid away from the first outlet (drain) so as to give more time for the liquid to become calm and for any entrained gas to escape from the liquid by buoyancy before reaching the first outlet.

Preferably, the first outlet drains the liquid from the collection chamber and communicates with the collection chamber at a location disposed in the opposite direction from the extraction aperture compared to the axial direction of flow of the liquid-gas mixture along the separation chamber. This is also the direction given to the liquid by the angled guide means. Thus, the path length between the extraction aperture and the first outlet is made as large as possible for a given collection chamber length so as to calm the separated liquid and allow entrained gas to escape before being drained.

Preferably, the first outlet communicates with a first arm of a U-tube, the second arm of the U-tube communicating with the flow downstream of the separation chamber at a liquid reintroduction point so as to reintroduce the separated liquid into the flow. The term “U-tube”, as used herein, is not limited to a tube which, in use, has a vertical first arm and a vertical second arm. Rather, the U-tube may have a first and/or second arm which angles away from the vertical. For example, a U-tube in which at least a portion of the first arm is at an angle in the range from 30° to 60° (and preferably at an angle of about 45°) to the vertical can advantageously promote the coalescence and removal of gas bubbles entrained in the liquid.

Preferably, the first outlet is at a lower level than the liquid reintroduction point. This is to account for the difference in pressure at the outlet compared to the liquid reintroduction point. In use, the hydrostatic pressure in the collection chamber will give a difference in height of the liquid surface in the first arm compared to that in the second arm.

Preferably, the first arm of the U-tube has at least twice the capacity than that of the second arm (e.g. by having a diameter which is at least about 1.4 times greater than that of the second arm). This reduces the average flow velocity of the liquid in the first arm compared to the second arm. This allows any gas bubbles entrained in the separated liquid time to coalesce and/or rise to the surface in the first arm. Removing the bubbles in this way increases the accuracy of subsequent measurements of the oil:water fraction and the liquid flow rate.

Particularly if first arm is substantially vertical, the liquid drained into the first arm may be encouraged to swirl by draining liquid swirl promoting means. Gentle swirling of the liquid in this way can encourage coalescence of bubbles in the liquid, larger bubbles rising through the liquid back into the collection chamber more quickly than smaller bubbles.

Typically, the draining liquid swirl promotion means is a helical insert in the first arm of the U-tube. Alternatively, the draining liquid swirl promotion means is an arrangement of fins that promotes swirling of the liquid as it drains into the first arm of the U-tube.

Preferably, the apparatus includes measurement means for measuring properties of the separated liquid. The measurement means may include a volumetric flow measurement device and/or a densitometer and/or a water-liquid ratio meter. Preferably, these are located to measure the liquid in the second arm of the U-tube. This is preferred because at this location, the liquid should be as free from gas bubbles as possible. However, the measurement means may also be located at the inter-arm section of the U-tube, as the liquid here should also be relatively free from gas bubbles. Reducing the bubble content of the liquid for these measurements typically increases the accuracy of the measurements.

Additionally or alternatively, the apparatus may include one or more ports for sampling separated liquid. Such ports may be located along the second arm of the U-tube for the same reason as set out above.

Preferably, the apparatus includes a measurement means located to measure the total volumetric flow rate at the inlet. The measurement means may be a differential pressure flow meter such as an orifice place but is preferably a Venturi-type flow meter.

It is to be understood that the preferred features of the first aspect may be combined in any combination with any of the aspect of the invention and/or any preferred feature of any other aspect of the invention.

In a second aspect, the present invention provides a conduit for conveying hydrocarbon well production fluid having a flow separator according to the first aspect located between an upstream portion of the conduit and a downstream portion of the conduit.

In a third aspect, the present invention provides a method of retrofitting a flow separator according to the first aspect to an existing conduit for conveying hydrocarbon well production fluid including the step locating and fitting the flow separator between an upstream portion of the conduit and a downstream portion of the conduit.

In a fourth aspect, the present invention provides a hydrocarbon well production fluid metering system including a flow separator according to the first aspect.

In a fifth aspect, the present invention provides a sub-sea hydrocarbon well production fluid metering system including a flow separator according to the first aspect.

In a sixth aspect, the present invention provides a method for measuring the flow of a flowing mixture of liquid and gas components in a flow conduit using a flow separator, the flow separator having:
a separation chamber;
a collection chamber communicating with the separation chamber via an extraction aperture in the wall of the separation chamber,
   the method including promoting swirling of the flow in the separation chamber so that the liquid in the mixture is urged towards the internal surface of the separation chamber which guides the swirling liquid to the extraction aperture, located along the swirl path of the liquid to be separated.

Preferably, the flowing mixture is a hydrocarbon well production fluid.

### Notation

The following notation is used herein:
Q= mass flow rate
q= volumetric flow rate
V= velocity =q/(cross-sectional area)
d= pipe diameter
L= length of centrifugal pipe
GVF= gas volume fraction
GOR= gas oil ratio
wlr= water liquid ratio
δ= uncertainty in x
α= hold up
t= retention time
ρ= density
Δρp= density contrast
g= acceleration due to gravity
E= measure of separation efficiency
ω= angular velocity (rad/s)
r= radius of gyration
n= number of revolutions
F_{centrifugal}= centrifugal force
β= ratio of the throat diameter to the inlet diameter of a venturi/orifice plate
A_{T}= Venturi throat cross-sectional area
dPᵥₑₙₜᵤᵣᵢ= Venturi differential pressure
K= flow coefficient
C= discharge coefficient
E= gas expansivity

### BRIEF DESCRIPTION OF THE DRAWINGS

FIG. 1 shows a schematic side cross sectional view of a flow separator according to an embodiment of the invention.

FIG. 2 shows a partial schematic cross sectional view from above of the flow separator of FIG. 1.

FIG. 3 shows a partial schematic cross sectional view of the separation and collection chambers along the longitudinal axis of those chambers.

FIG. 4 shows an enlarged schematic cross-sectional view of the separation chamber of FIG. 3.

FIG. 5 shows a schematic side cross sectional view of a flow separator according to another embodiment of the invention.

FIG. 6 shows an enlarged schematic cross-sectional view of an alternative form for the separation chamber.

FIG. 7 shows schematically a well testing system in which a flow separator of the present invention is positioned on a gas line between a well test separator and a gas flare.

FIG. 8 shows schematically another well testing system in which a flow separator of the present invention is positioned on the flow line between a multiphase flow meter and a multiphase flare.

### DETAILED DESCRIPTION OF THE PREFERRED EMBODIMENTS

Before looking at the embodiments of the invention in detail, the technical problems to be addressed by the embodiments will first be looked at in more detail.

The limitations of the abovementioned Schlumberger VenturiX™ system have been investigated by the present inventors and quantified using a 52 mm Schlumberger PhaseWatcher™ at a GVF of 90% or greater up to 100% using oil and nitrogen flows at line pressures of between 15 and 60 bara (i.e. between 1.5 and 6.0 MPa absolute). The results show that for GVF<97% the gas rate was within ±10% reading, the absolute error in the wlr was 0.05 and the absolute error in the liquid rate was ±2 m³/h (300 bpd). It is intended that the preferred embodiments of the invention will give improved accuracy results for GVF of 97% and above.

Looking at the error budget for the Schlumberger VenturiX™ model, the model predicts the liquid and gas volumetric flow rates from the GVF (derived from the nuclear gas hold up and a Slip Law) and the total flow rate (derived from the differential pressure across the Venturi and the nuclear mixture density).

The wlr is computed from the water and oil nuclear hold up measurements:

$${q}_{Gas} = {q}_{Total} GVF$$

$${q}_{Liquid} = {q}_{Total} ( 1 - GVF )$$

$$wlr = \frac{{α}_{Water}}{1 - {α}_{Gas}}$$

$${( \frac{δ {q}_{Gas}}{{q}_{Gas}} )}^{2} = {( \frac{δ {q}_{Total}}{{q}_{Total}} )}^{2} + {( \frac{δ GVF}{GVF} )}^{2}$$

$${( \frac{δ {q}_{Liquid}}{{q}_{Liquid}} )}^{2} = {( \frac{δ {q}_{Total}}{{q}_{Total}} )}^{2} + {( \frac{δ GVF}{1 - GVF} )}^{2}$$

$${( \frac{δ wlr}{wlr} )}^{2} = {( \frac{δ {α}_{Water}}{{α}_{Water}} )}^{2} + {( \frac{δ {α}_{Gas}}{1 - {α}_{Gas}} )}^{2}$$

The fractional error in the liquid flow rate (q_{liquid}) is a function of (1−GVF)⁻¹, which becomes very large when the GVF approaches unity. Similarly, the fractional error in the wlr is a function of (1−α_{Gas})⁻¹, which becomes very large when α_{Gas} approaches unity. Therefore an accurate measurement of the liquid flow rate cannot be deduced from a measurement of the total mass or volume flow rate. Furthermore, accurate measurement of the wlr is not possible by any techniques when a significant volume fraction of gas is present (e.g. GVF greater than about 98%).

The preferred embodiments of the invention propose that a device is inserted into a pipeline downstream of a Venturi flow meter. The pipeline carries a flowing mixture of gas and liquid, e.g. hydrocarbon gas, oil and water. The device allows the extraction of liquid from the flow. The liquid flow rate and the wlr are measured using known meters and then the liquid is re-injected into the pipeline to join the gas. Thus, three measurements are to be made: the differential pressure across the Venturi, the extracted liquid flow rate and the wlr.

In the preferred embodiments, the gas flow rate is derived from the liquid flow and the Venturi differential pressure using a model.

For example, R. N. Steven, “Wet Gas Metering with a Horizontally Mounted Venturi Meter”, Flow Measurement and Instrumentation, 2002, 361-372, and Z. H. Lin, “Two-Phase Flow Measurements with Orifices”, Encyclopaedia of Fluid Mechanics, Chapter 29, Vol. 3, Gulf, 1986 have proposed correlations for calculating the flow rate of a multi phase mixture through an orifice plate or a Venturi flow meter, the aim being to find a universal expression/experimental correlation for calculating the flow rate at all GVF values. The correlations, are also disclosed in GB-A-2399641, the content of which is incorporated herein by reference. The differences between the correlations are small when they are used to calculate the flow rate of a wet gas. Steven ibid. provides a summary of two wet gas correlations for horizontal Venturi flow meters and five for orifice plate flow meters. The correlations assume that the flows are incompressible, there are no appreciable thermodynamic effects and the liquid flow rate is initially known.

The correlations are based on the principle of relating the gas volumetric flow rate, q_{gas}, to a “pseudo single phase gas volumetric flow rate”, q_{single phase}, calculated from the standard Venturi/orifice plate equation using the measured differential pressure, dPᵥₑₙₜᵤᵣᵢ, and the gas density, ρ_{gas}:

$${q}_{single phase} = {K}_{gas} {A}_{T} \sqrt{\frac{2 {dP}_{Venturi}}{{ρ}_{gas}}}$$

$${q}_{gas} = f ( {q}_{single phase} , {q}_{liquid} / {q}_{gas} )$$

where A_{T} is the Venturi throat cross-sectional area, K_{gas} is a function of the discharge coefficient, gas expansivity and Venturi dimensions (K_{gas}=C_{gas}ε/(1−β⁴)^{0.5}), and liquid is the liquid volumetric flow rate.

Essentially, correcting q_{single} phase for multi phase flow based on the relative gas/liquid phase content gives the gas flow rate. However, in order to perform this correction the correlations require an additional input, which can be in the form of the liquid flow rate.

The oil and water flow rates are calculated from the wlr and the liquid flow rate measurements as follows:

$${q}_{Gas} = f ( {dP}_{Venturi} , {q}_{Liquid} )$$

$${q}_{Water} = {q}_{Liquid} wlr$$

$${q}_{Oil} = {q}_{Liquid} ( 1 - wlr )$$

$${( \frac{δ {q}_{Oil}}{{q}_{Oil}} )}^{2} = {( \frac{δ {q}_{Liquid}}{{q}_{Liquid}} )}^{2} + {( \frac{δ wlr}{1 - wlr} )}^{2}$$

$${( \frac{δ {q}_{Water}}{{q}_{Water}} )}^{2} = {( \frac{δ {q}_{Liquid}}{{q}_{Liquid}} )}^{2} + {( \frac{δ wlr}{wlr} )}^{2}$$

It should be noted that as the wlr approaches 1, the error in the oil flow rate increases significantly. Similarly, as the wlr approaches 0, the error in the water flow rate increases significantly.

The embodiments of the invention preferably allow the operating envelope of the Schlumberger VenturiX™ system to be increased up to GVF of 100%. The flow rate and wlr of the liquid are additional measurements. The embodiments use centrifugal force to separate the liquid and gas phases. In effect, the preferred embodiments of the invention act as assisted gravity separators of gas and liquid.

Conventional gas-liquid separators rely on the density contrast Δρ between the two phases, the acceleration due to gravity g and the “retention” or “settling” time t. The product of these three quantities provides a measure of the separation efficiency E:

E(gravity)=Δρ.g.t

where Δρ.g can be considered as the separation force.

When a centrifugal force is used to separate gas and liquid the separation efficiency is given by

E(centrifugal)=Δρ.r.ω².t

where r is the radius of gyration and ω is the angular velocity.

In the case of centrifugal separation, the residence time is normally less than in the gravity separator, but the separation force Δρ.r.ω² is significantly larger. It is considered that oil separated using a centrifugal separator will usually contain less non-solution gas (i.e. bubbles) than that from units that do not use centrifugal force.

Thus, the preferred embodiments of the invention utilise an apparatus that can be retrofitted to be located in a pipeline downstream of a Schlumberger VenturiX™ system, such as a 52 mm Schlumberger VenturiX™ system.

It is preferred that the system gives rise to only a minimum pressure drop or pressure loss in the flow. Furthermore, it is also preferred that the system does not use valves or moving parts, since these can give rise to maintenance concerns. Still further, it is preferred that the system can be used in sub-sea applications.

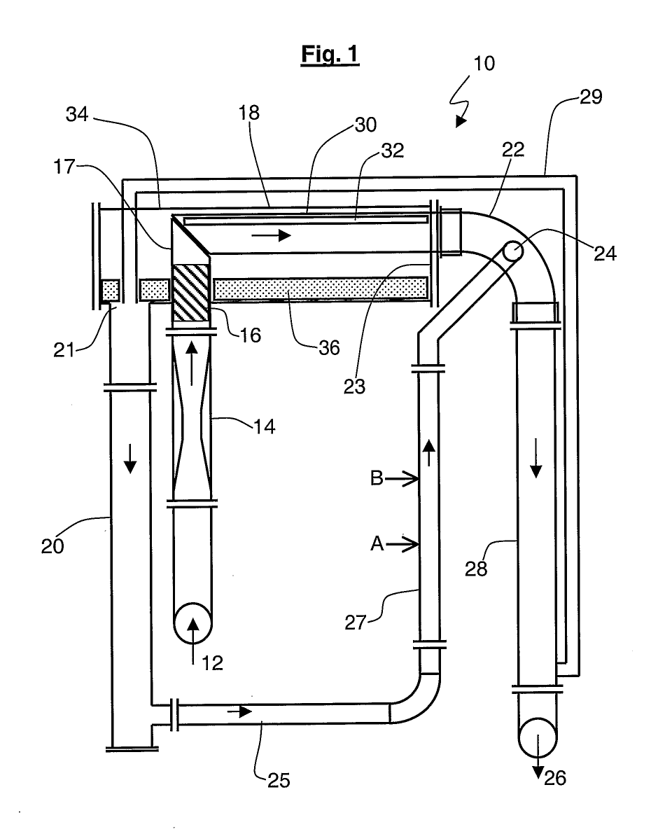

FIG. 1 shows a schematic view of a flow separator 10 according to an embodiment of the invention located along a pipeline between an upstream pipeline portion (not shown) and a downstream pipeline portion (not shown). Arrow 12 indicates the direction of flow of a mixture of liquid and gas (not shown) into the apparatus. The flowing mixture of liquid and gas is guided through a Venturi flow meter 14 and into a liquid separator 18 via a swirl generator 16 located in inlet 17. The liquid separator separates much if not all of the liquid from the flow. The liquid is conveyed via conduit 20 and the gas is conveyed via conduit 22. The two are mixed back together at a liquid return point 24, after which the flowing mixture of liquid and gas is conveyed along conduit 28 to downstream pipeline portion (not shown) in the direction indicated by arrow 26.

The way in which the apparatus separates the liquid from the flowing liquid-gas mixture will now be described in more detail. The liquid separator 18 includes a cylindrical separation chamber 30 whose longitudinal axis extends in a direction transverse to the direction of flow of the liquid-gas mixture through the Venturi 14. The separation chamber has an elongate slot 32 formed in the wall of the chamber, substantially parallel with the longitudinal axis of the chamber. This slot will be described in further detail below.

The liquid separator 18 has a cylindrical collection chamber 34 formed around at least the slotted part of the separation chamber. The longitudinal axis of the collection chamber is substantially parallel to that of the separation chamber. As will be described further below, the collection chamber is arranged to collect liquid that is extracted from the flow in the separation chamber.

In the present embodiment, the Venturi 14 has an inlet of 101 mm diameter and a throat diameter of 51 mm. The inlet 17 has a diameter of 101 mm and the separation chamber 30 has a diameter of 101 mm. The collection chamber 34 has a diameter of 280 mm and a horizontal length of 750 mm. The outlet 28 has a diameter of 101 mm. The length of the liquid extraction slot is 600 mm. The main drain 20 has diameter 101 mm and a height of 1700 mm. Gas pipe 29 for extracting gas from main drain 20 has a diameter of 25 mm. All diameters are given for internal dimensions.

Thus, the embodiment shown in FIG. 1 (and indeed the embodiment shown in FIG. 5) is a compact device that is capable of being transported to a pipeline or other conduit of interest and retrofitted to an existing venturi system. This portability of the device is an important advantage over pure gravity separators that have an equivalent capacity.

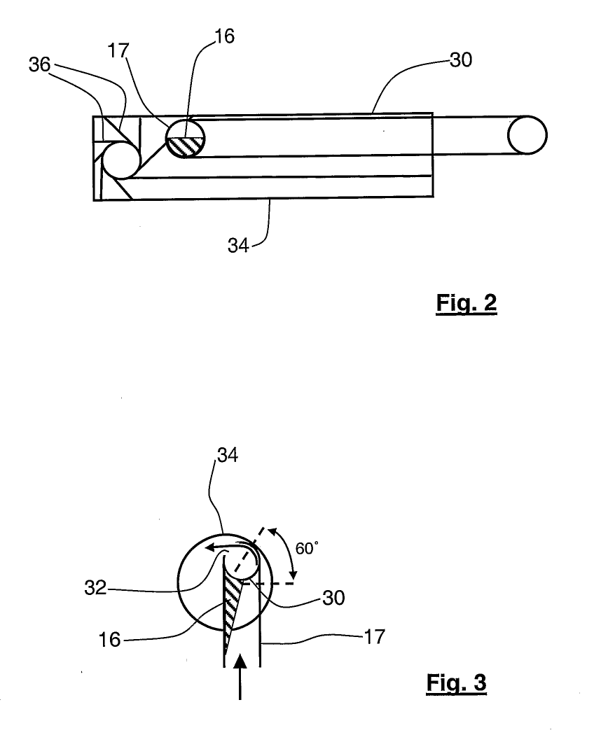

FIG. 2 shows a sectional schematic view of the collection chamber 34 and the separation chamber 30. Also shown is the swirl generator 16. As can be seen, the swirl generator blocks one lateral side of the upright inlet into the separation chamber 30. The flowing mixture makes a 90° change in direction on flowing into the separation chamber because the inlet to the liquid separator is upright (in this example) and the separation chamber itself is aligned substantially horizontally. Thus, having the swirl generator disposed at one lateral side of the upright inlet of the liquid separator means that the flow is concentrated on the opposite lateral side of the upright inlet. However, by immediately turning this flow through a right angle into the separation chamber, the flow along the cylindrical separation chamber is given a circumferential velocity component. In other words, the flow along the separation chamber is a swirling or substantially helical flow.

The ratio of the contraction given by the swirl generator in the inlet to the separation chamber is β. The axial velocity Vₐₓᵢₐₗ and the angular velocity ω in the separation chamber (of diameter d) are given by (assuming no frictional losses:

$${V}_{Axial} = \frac{4 {q}_{Total}}{π {d}^{2}}$$

$${V}_{Tangentia} = \frac{1}{{β}^{2}} {V}_{Axial}$$

$$ω = \frac{2}{{β}^{2}} \frac{{V}_{Axial}}{d}$$

The fluid is assumed to spiral along the separation chamber with a velocity Vₛₚᵢᵣₐₗ, given by:

$${V}_{Spiral} = \sqrt{{V}_{Axial}^{2} + {V}_{Tangential}^{2}}$$

$${V}_{Spiral} = {V}_{Axial} \sqrt{( 1 + \frac{1}{{β}^{4}} )}$$

The angle θ the velocity vector Vₛₚᵢᵣₐₗ makes with the horizontal is given by:

$$tan θ = \frac{{V}_{Tangential}}{{V}_{Axial}}$$

$$θ = {tan}^{- 1} ( \frac{1}{{β}^{2}} )$$

The tangential velocity generates a centrifugal force F_{Centrifugal} which separates the phases according to the phase density:

F_{centrifugal}∝ρ.r.ω²

The denser phases (liquid) are thrown to the greatest radius with the lighter phases (gas) inside, i.e. a rotating annular flow. Assuming that all of the liquid phases are thrown to the wall of the separation chamber and no slip velocity between the gas and liquid phases, it can be shown that at 95% gas hold up, the liquid film at the wall of the separation chamber occupies about 2.5% of the separation chamber radius.

It is assumed that the greater the number of revolutions of the spiral flow along the separation chamber, the greater will be the separation efficiency. If L is the length of the separation chamber of diameter d and t is the time for the fluid to pass along the line (t=residence time) then:

$$t = \frac{L}{{V}_{Axial}} = \frac{Length of spiral path}{{V}_{Spiral}}$$

$$Length of spiral path = \sqrt{[ {( n π d )}^{2} + {L}^{2} ]}$$

Where n is the number of revolutions, so:

$$n = \frac{L}{π d} \frac{1}{{β}^{2}} β \leq 1$$

To complete at least one revolution, the centrifugal force must be greater than the gravitational force:

$$\frac{{V}_{Spiral}^{2}}{r} \geq g$$

$${q}_{Total}^{Minimum} \approx π {β}^{2} \sqrt{\frac{{d}^{5} g}{32}} \cdot 300 {m}^{3} \text{/} h$$

If the fluid does not complete one revolution then it is assumed that the flow is stratified with the liquid at the bottom.

Looking now at the separation efficiency, this has been defined above and can be written as:

$$E ( centrifugal ) = \frac{8}{π} q \frac{L}{{d}^{3} {β}^{4}}$$

The residence time of a conventional gravity separator usually varies between 1-3 minutes (no foaming) and 5-20 minutes (foams). It can be shown that, for a ratio of length to diameter (L/d) of 3 and β=0.5, centrifugal separation is more efficient than gravity separation (with residence time of 3 minutes) for flow rates of more than 500 m³/h.

It will be understood that the invention is not necessarily limited to the form of swirl generation described above. For example, swirl could be introduced into the flow via an input substantially tangential to the inner wall of the separation chamber. Alternatively, vanes or ribs could be used to swirl the flow along the inlet to the separation chamber. In that case, it would not be necessary to have a direction change between the inlet and the separation chamber.

FIG. 3 shows another schematic partial sectional view of the inlet 17, the separation chamber 30 and the collection chamber 34. As can be seen in this drawing, the swirl generator is wedge shaped, in order to reduce the effect of the swirl generator on the turbulence of the flow. On entry into the separation chamber, the flow swirls in the separation chamber. The flowing mixture is made up of liquid (dense) and gas (less dense). Centrifugal effects force the liquid towards the wall of the separation chamber. Thus, the liquid flows along the internal surface of the separation chamber in a swirling path.

Located along the swirling path of the liquid in the separation chamber wall is extraction slot 32. When the swirling liquid encounters the extraction slot, it exits though it into the collection chamber 34.

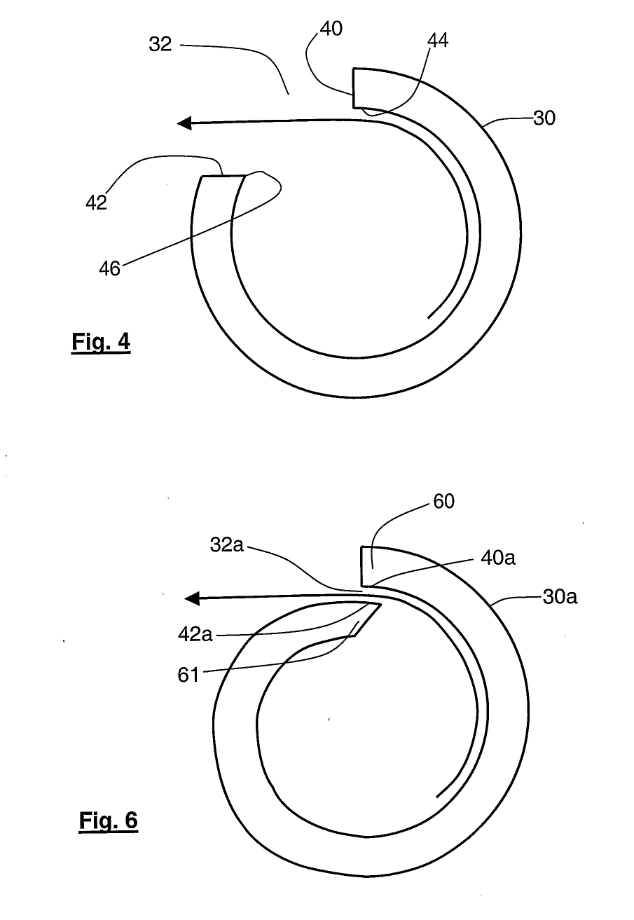

FIG. 4 shows an enlarged schematic cross section of the separation chamber 30. The extraction slot 32 has a first face 40 and a second face 42, both of which are substantially parallel to the longitudinal axis of the separation chamber. The width of the slot (i.e. the angular distance between the first and second faces) is about 55°. First face 40 is formed as a substantially radial face, because the orientation of this face has little impact on the extraction of liquid from the flow. However, second face 42 is formed so as to be substantially parallel (in a direction transverse to the longitudinal axis of the separation chamber) to the exit direction of the liquid from the separation chamber. In other words, this second face is formed so as to be substantially parallel to the tangent of the inner surface of the wall of the separation chamber at a portion 44 immediately adjacent the first face. In this way, the second face of the slot interferes as little as possible with the liquid exiting through the slot into the collection chamber. For relatively high liquid volume fractions, the leading edge 46 of the second face of the slot can be thought of as “slicing” the swirling liquid flow from the gas flow.

As shown in FIG. 3, the separation chamber is typically not located coaxially with the collection chamber. Instead, it is located off-centre from the centre of the collection chamber.

As shown in FIG. 3, the closest point of approach between the outer surface of the wall of the separation chamber to the inner surface of the wall of the collection chamber is at about 60° from a horizontal plane along the longitudinal axis of the collection chamber. The extraction slot in the separation chamber can then be oriented so that the liquid exiting through the slot impinges on the inner surface of the wall of the collection chamber as close to tangentially as possible but as far away from the slot as possible. This is to avoid a large portion of the liquid from bouncing straight back into the slot. In practice, these desiderata are in conflict, so the position of the slot shown in FIG. 3 with respect to the collection chamber is something of a compromise. The liquid exiting tangentially from the separation chamber impinges on the inner wall of the collection chamber at an angle to the tangent of the wall of between about 10° and about 45°.

The liquid exiting the extraction slot into the collection chamber may itself swirl around the inner surface of the wall of the collection chamber. As is seen in FIG. 3, the location of the separation chamber close to or against the inner surface of the wall of the collection chamber prevents the build-up of a swirling flow of liquid around the collection chamber. In this way, the outer surface of the separation chamber acts as a baffle against the liquid in the collection chamber.

Alternatively, a separate baffle may be located between the outer wall of the separation chamber and the inner wall of the collection chamber.

The diameter of the collection vessel should be large enough so that there is sufficient space beneath the separation chamber for liquid to collect. Furthermore, locating the slot of the separation chamber upwardly from the base of the collection chamber reduces the likelihood of swamping of the slot with liquid from the collection chamber.

Looking back again at FIG. 1, the remaining gas (and possibly some liquid) in the swirling flow in the separation chamber is conveyed along the separation chamber to conduit 22.

The separated liquid collects at the base of the collection chamber. In practice, if the exit velocity of the liquid from the extraction slot is high, the liquid in the base of the collection chamber will be agitated. For this reason, the liquid drain 21 is located not forwardly of the extraction aperture but rearwardly of the extraction aperture (in terms of the overall flow direction in the separation chamber). In this way, the separated liquid has the opportunity to calm down, e.g. by impinging on the forward end face 23 of the collection chamber. In the collection chamber, the liquid finds its own level and drains away down the drain 21.

Main drain (first arm) conduit 20, transverse (inter-arm) conduit 25 and return (second arm) conduit 27 together form a U-tube. The main drain conduit 20 is formed with a large cross section so that the liquid within it has a high average residence time (i.e. a low velocity). This is so that the liquid has more time to settle. In particular, it is preferred that as many gas bubbles as possible are removed from the liquid in the main drain conduit.

In order to improve the coalescence of bubbles in the main drain conduit, it is preferred to cause the liquid in the main drain conduit to swirl gently. This swirling is provided by fins 36 radiating from the drain 21 in collection chamber 34, as shown in plan view in FIG. 2 (the height and radial extent of the fins are indicated by shading in FIG. 1).

Gas extracted from the main drain conduit is allowed to flow back into the main flow along pipe 29, the return point of pipe 29 being at a relatively low pressure position in the main flow.

After the liquid has spent enough time in the main drain conduit 21 to become as degassed as possible in the circumstances, it is conveyed along transverse conduit 25 to return conduit 27. Measurements of liquid flow rate and density or wlr can then be taken at locations A and B in the return conduit using sensors well known to the skilled person for measurements of two phase liquid mixtures.

For example, to measure the flow rates of a liquid containing oil and water phases, one option is to measure the total liquid flow rate and the water-liquid ratio:

q_{Water}=q_{Total Liquid}·wlr

q_{Oil}=q_{Total Liquid}−q_{Water}

To measure the total liquid flow rate, a liquid flow meter-such as a Coriolis meter, ultrasonic meter, turbine, venturi, or orifice plate can be used.

The wlr can be measured directly, for example using a microwave meter (manufactured e.g. by Agar, Phase Dynamics etc.) or optically. Alternatively, it can be measured indirectly by measuring the liquid density and then deriving the wlr from knowledge of the single phase liquid densities:

$$wlr = \frac{{ρ}_{Liquid} - {ρ}_{Oil}}{{ρ}_{Water} - {ρ}_{Oil}} .$$

However, this approach does require a density contrast between the water and oil phases. Liquid density can be obtained using e.g. a Coriolis meter, a vibrating element tuning fork densitometer etc.

In an alternative embodiment, locations A and B provide sampling ports for extracting a liquid sample for later testing from the return conduit 27.

After travelling up the return conduit 27, the separated liquid re-enters the flow at liquid return point 24. It is noted here that FIG. 1 shows the liquid return point at a higher level than the level of liquid in the collection chamber 34. This is due to the differential pressure across the U-tube. The difference in levels helps to prevent automatic siphoning of the liquid in the U-tube.

The U-tube acts as a self-regulating liquid trap. If P₁ is the pressure at the inlet and P₂ is the pressure at the outlet of the U-tube, then the pressure difference P₁-P₂ is mainly due to the frictional pressure loss in the fluid (ideally a gas of density ρ_{Gas} and velocity V_{Gas}) flowing in the main line 22:

$${P}_{1} - {P}_{2} = \frac{2 f {ρ}_{Gas} {V}_{Gas}^{2} L}{D}$$

where f is the Fanning friction factor, L is the path length and D is the pipe diameter.

Considering the case where there is only gas flowing into the apparatus and the U-tube is full of liquid. In equilibrium, the hydrostatic head due to the difference in the heights of the liquid levels in the two legs of the return line balances the pressure losses on the gas line 22 and the liquid is static (i.e. the U-tube is a simple manometer). Now considering the case where there is liquid in the main gas flow that is extracted by the separation chamber and enters the U-tube. This reduces the liquid hydrostatic head and the system returns to the balance condition by liquid flowing out of the return line. This system acts as a control valve with no moving parts.

In equilibrium the liquid hydrostatic head, h, in the liquid return line balances this pressure difference:

P₁−P₂=ρ_{Liquid}gh ++frictional pressure losses when liquid flows out

where ρ_{Liquid} is the density of the liquid in the U-tube and h is the difference in height of the liquid in the U-tube.

In practice, the height difference h should be kept small so as to keep the total system height small because, in some circumstances the liquid density might be low (e.g. about 600 kg/m³ for condensate). Therefore the pressure difference P₁-P₂ should be small, which requires that the distance L, measured in the gas flow line, should be as low as possible.

An advantage of this system is that any liquid that enters the U-tube can only exit into the main gas line.

The total pressure drop across the system can be expressed as a function of the differential pressure across the Venturi. Tests have shown that a typical total pressure drop is about 2.7 times the differential pressure across the Venturi. The pressure drop across the swirl generator is about 1.6 times the differential pressure across the Venturi. It should be noted that the pressure drop across the constriction (β=0.5) formed by the swirl generator 16 in the inlet 17 would be of the order of the differential pressure across the Venturi. Therefore, the change in fluid direction into the separation chamber contributes about 0.6 times the differential pressure across the Venturi to the total pressure drop across the system.

FIG. 5 shows an alternative embodiment of the invention. Similar reference numerals are given to similar features shown in FIG. 1, but a description of those similar features is omitted here.

In this embodiment, a baffle plate 50 is located to intercept liquid exiting the extraction slot 32. It is found that a large proportion of the liquid extracted via the separation chamber leaves the extraction slot at the upstream end of the separation chamber compared to the downstream end. The baffle plate is placed at an angle (about 45°) to the longitudinal axes of the separation chamber and collection chamber. The extracted liquid hitting the baffle plate is diverted towards the forward end face 23 of the collection chamber. This reduces the spray of the liquid back into the separation chamber via the slot. It also provides a direction of the separated liquid away from the drain 21, reducing the turbulence and hence gas entrapment at the drain.

A helical insert 52 is located along the wall of the separation chamber. This is forms a relatively shallow helical rib along the internal surface of the cylindrical wall of the separation chamber. The effect of the helical insert is as an additional swirl promoter. It can in particular increase or maintain the steepness of the swirl in the separation chamber and can therefore improve the separation efficiency of the separator by causing the liquid in the swirling flow to perform more turns around the separation chamber per unit length for a given liquid flow rate.

In another embodiment (not shown) the longitudinal length of the extraction slot is reduced to be two thirds or less (or one half or less) of the length of the separation chamber located within the collection chamber. The slot is preferably located towards the upstream end of the separation chamber. This is because most of the extracted liquid exits through the slot close to the upstream end of the separation chamber. Reducing the effective length of the slot can reduce the amount of liquid than bounces or sprays back into the slot from the collection chamber further along the separation chamber.

In the embodiment illustrated in FIG. 5, the fins 36 are removed and a helical insert 54 is located in the main drain conduit. The effect of the helical insert is to promote gentle swirling of the liquid in the main drain conduit and hence to promote coalescence of bubble in the liquid contained there. In this embodiment, the gas pipe 29 is removed since it has been found that the gas removed from the liquid in the main drain is able to re-enter the separation chamber via slot 32 so as to re-enter the main gas flow.

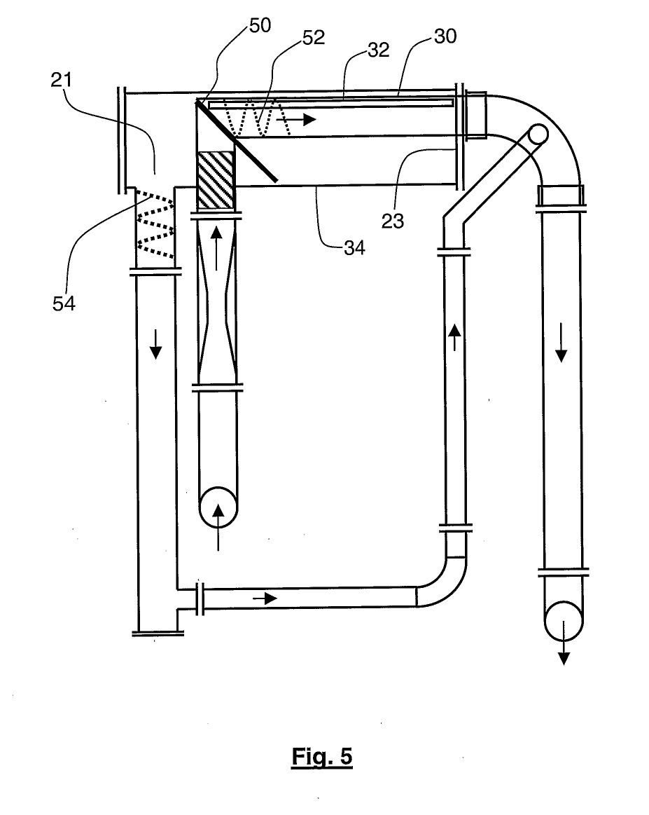

FIG. 6 shows an enlarged schematic cross section of an alternative form for the separation chamber 30a, which may replace the separation chamber of any of the flow separator embodiments discussed above.

The separation chamber 30a is still substantially cylindrical in shape. However, the elongate slot 32a is now formed by chamber wall lips 60, 61. These overlap in the angular direction, but are spaced in the radial direction. Inner lip 61 may be chamfered to reduce disturbance to the swirling path of the flow inside the chamber. The first 40a and second 42a faces of the slot are thus formed by facing surfaces of the chamber wall.

This arrangement keeps second face 42a substantially parallel to the exit direction of liquid from the chamber, and provides an alternative geometry for “slicing” the swirling liquid flow from the gas flow.

One of the uses of the flow separator discussed above both in general terms and in relation to detailed embodiments, is as a part of a fluid metering system. However, other applications of the separator are also envisaged.

For example, when conducting well testing operations on hydrocarbon wells that are not connected to a hydrocarbon gathering or processing plant, it is necessary to dispose of the effluent by burning its combustible fractions. These are the gaseous and liquid hydrocarbon phases that have been separated by a well test separator, which is a large size vessel of typically 42 to 48″ (1.1 to 1.2 m) diameter and 10 to 15 ft (3.0 to 4.6 m) long rated to 100 bars or more.

Conventionally, the oil is burned using a dedicated well test oil burner, and the gas is burned through a gas flare. Both operations are conducted at atmospheric pressure, whereas the separation of the constituents is performed at an intermediate pressure between the flowing pressure at the wellhead and atmospheric pressure.

Due to pressure losses in the well test separator pressure control device and in the gas line, the gas exiting the separator undergoes further pressure reduction and cooling as it goes from the separator to the gas flare. As a result, a secondary liquid phase may develop along the gas line, and the gas flare receives a wet gas mixture with two distinct liquid and gas phases.

Another reason for the presence of liquid in the gas line, is the phenomenon known in the industry as liquid carry-over into the well test separator gas outlet. Essentially, incomplete separation of the liquid and gas phase inside the separator (due e.g. to foaming or improper separator operation) can also lead to the gas flare receiving liquid and gas phases.

The liquid fraction of the wet gas mixture tends to deposit on the inner wall of the gas line to form a moving film.

Typically, this film is poorly atomised at the flare tip and only partially burned. The unburned part drops to the ground, or to the surface of the sea during offshore operation, and causes hydrocarbon pollution. It is commonly known as liquid fall-out.

Therefore, a further use of the flow separator of the present invention is as a liquid interceptor upstream of the flare. The essentially dry gas exiting the flow separator can then be burned normally in a gas flare, and the liquid recovered by the flow separator can be re-injected into the gas flame through an atomizer (pressure or pneumatically driven) for incineration. A booster pump or ejector driven e.g. by the dry gas could be included on the flow separator's liquid outlet to drive the atomisation. Alternatively, the liquid stripped out by the separator may be collected for later disposal. Either way, liquid fall-out can be reduced or eliminated.

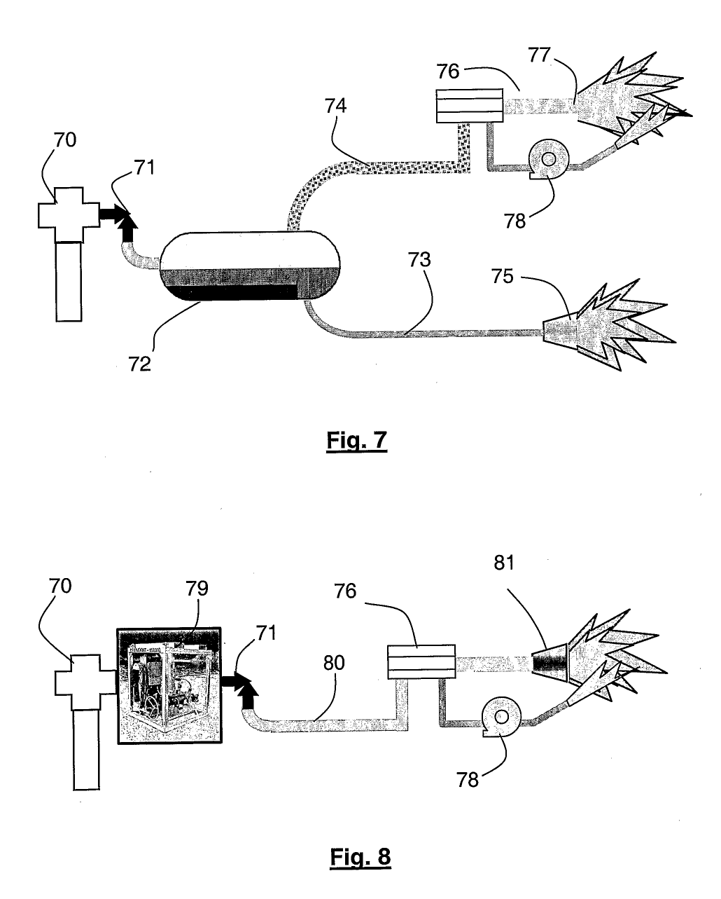

Thus, a well testing system may have a flow separator of the present invention positioned on a gas line between a well test separator and a gas flare, and FIG. 7 shows schematically an example of such a system. Flow from a wellhead 70 is controlled by a choke 71. The flow passes to a well test separator 72 and is separated to flow along an oil line 73 and wet gas line 74. The oil line ends at an oil burner 75. The wet gas line travels to a flow separator 76 according to the present invention. At the flow separator, the liquid in stripped from the wet gas. The dry gas exiting the flow separator is burnt at a flare 77. The stripped liquid is atomised (the atomisation being powered by a pump or ejector 78) and fed into the gas flare where it also incinerates.

There is a trend in the industry to replace the metering function of well test separators with multiphase flow meters. However, the gas and liquid phases are not separated out by such meters. Therefore, it is also envisaged that the flow separator of the present invention may be installed downstream of a multiphase flow meter to separate the phases so that they can be respectively sent to a gas flare and an oil burner.

Alternatively, the liquid stream can be atomised as discussed above and fed into the gas flare to achieve multiphase burning at the flare.

Thus, a well testing system may have a flow separator of the present invention positioned on a flow line between a multiphase flow meter and a flare. FIG. 8 shows schematically an example of such a well testing system, in which flow line 80 from multiphase flow meter 79 leads to the flow separator and thence to multiphase flare 81. The flow separator allows efficient multiphase burning by separating the liquid from the flow so that it can be fed into flare in an atomised state. Equivalent features have the same reference numbers in FIGS. 7 and 8.

The embodiments above have been described by way of non-limiting example. On reading this disclosure, modifications of these embodiments, further embodiments and modifications thereof will be apparent to the skilled person and as such are within the scope of the invention.

1. A flow separator for separating liquid from a flowing mixture of liquid and gas having:
an inlet for the flowing mixture;
swirl promotion means;
a first outlet for separated liquid;
a second outlet for the remaining flow;
a separation chamber with an extraction aperture for extracting the liquid to be separated; and
a collection chamber communicating with the first outlet and arranged to collect the separated liquid extracted through the extraction aperture from the separation chamber;
wherein, in use, the swirl promotion means promotes a swirling flow of the flowing mixture in the separation chamber and an internal surface of the separation chamber guides the swirling liquid to be separated to the extraction aperture, which is located along the swirl path of the liquid to be separated.

2. A flow separator according to claim 1 wherein the inner surface of the separation chamber provides a smooth curved path for the swirling liquid to the extraction aperture.

3. A flow separator according to claim 1 or claim 2 wherein the extraction aperture is located so as to allow the swirling liquid to exit the separation chamber substantially tangentially from the inner wall of the separation chamber.

4. A flow separator according to any one of claims 1 to 3 wherein the separation chamber has a swirl guide disposed on its inner surface to assist in promoting swirling flow of the liquid within the separation chamber.

5. A flow separator according to claim 4 wherein the swirl guide is a helical ridge or insert disposed against the internal surface of the wall of the separation chamber.

6. A flow separator according to any one of claims 1 to 5 wherein the extraction aperture is a slot, extending in a direction substantially parallel to the longitudinal axis of the separation chamber.

7. A flow separator according to any one of claims 1 to 6 wherein the extraction aperture has a face surface that is substantially aligned with the exit direction of the liquid.

8. A flow separator according to any one of claims 1 to 7 wherein the separation chamber is located within the collection chamber so that the exit direction of the liquid from the extraction aperture makes an angle of 45° or less with the tangent to the inner surface of the collection chamber.

9. A flow separator according to any one of claims 1 to 8 wherein angled guide means is provided externally of the extraction aperture to guide the exiting liquid in an axial direction along the collection chamber.

10. A flow separator according to any one of claims 1 to 9 wherein the first outlet drains the liquid from the collection chamber and communicates with the collection chamber at a location disposed in the opposite direction from the extraction aperture compared to the axial direction of flow of the liquid-gas mixture along the separation chamber.

11. A flow separator according to claim 10 wherein the first outlet communicates with a first arm of a U-tube, the second arm of the U-tube communicating with the flow downstream of the separation chamber at a liquid reintroduction point so as to reintroduce the separated liquid into the flow.

12. A flow separator according to claim 11 wherein the first outlet is at a lower level than the liquid reintroduction point.

13. A flow separator according to claim 11 or claim 12 wherein the first arm of the U-tube has at least twice the capacity of the second arm.

14. A flow separator according to any one of claims 11 to 13 wherein the liquid drained into the first arm of the U-tube is encouraged to swirl by draining liquid swirl promoting means.

15. A flow separator according to claim 14 wherein the draining liquid swirl promotion means is a helical insert in the first arm of the U-tube.

16. A flow separator according to any one of claims 11 to 13 wherein, in use, at least a portion of the first arm is at an angle in the range from 30° to 60° to the vertical.

17. A flow separator according to any one of claims 11 to 16 wherein the apparatus includes measurement means located along the second arm or the inter-arm section of the U-tube for measuring properties of the separated liquid.

18. A flow separator according to any one of claims 11 to 17 wherein the apparatus includes one or more ports located along the second arm or the inter-arm section of the U-tube for sampling separated liquid.

19. A flow separator according to any one of claims 1 to 18 wherein the apparatus includes a measurement means located to measure the total volumetric flow rate at the inlet.

20. A flow separator according to claim 19 wherein the measurement means is a Venturi differential pressure flow meter.

21. A conduit for conveying hydrocarbon well production fluid having a flow separator according to any one of claims 1 to 20 located between an upstream portion of the conduit and a downstream portion of the conduit.

22. A method of retrofitting a flow separator according to any one of claims 1 to 20 to an existing conduit for conveying hydrocarbon well production fluid, the method including the step locating and fitting the flow separator between an upstream portion of the conduit and a downstream portion of the conduit.

23. A hydrocarbon well production fluid metering system including a flow separator according to any one of claims 1 to 20.

24. A sub-sea hydrocarbon well production fluid metering system including a flow separator according to any one of claims 1 to 20.

25. A method for measuring the flow of a flowing mixture of liquid and gas components in a flow conduit using a flow separator, the flow separator having:
a separation chamber;
a collection chamber communicating with the separation chamber via an extraction aperture in the wall of the separation chamber,
the method including promoting swirling of the flow in the separation chamber so that the liquid in the mixture is urged towards the internal surface of the separation chamber which guides the swirling liquid to the extraction aperture, located along the swirl path of the liquid to be separated.

26. A method according to claim 25 wherein the flowing mixture is a hydrocarbon well production fluid.
